(19) United States
(12) Patent Application Publication
(10) Pub. No.: US 2010/0315328 A1
(43) Pub. Date: Dec. 16, 2010

(54) INTEGRATED CONTROL SYSTEM WITH MULTIPLE MEDIA SOURCES AND CORRESPONDING DISPLAYS

(75) Inventors: Bob Marcus, Lafayette, CA (US); Bob Gardyne, Oakland, CA (US)

Correspondence Address: Weaver Austin Villeneuve & Sampson LLP, P.O. BOX 70250, OAKLAND, CA, 94612-0250, US

(73) Assignee: RGB Spectrum, Alameda, CA (US)

(21) Appl. No.: 12/483,007

(22) Filed: Jun. 11, 2009

(51) Int. Cl. G09G 5/00

(52) U.S. Cl. 345/156; 345/1.3

(57) ABSTRACT

Mechanisms are provided for efficiently manipulating devices such as computer systems, cameras, recorders, sensors, etc., referred to herein as media sources. The media sources are connected to a control computer over a network. Output such as video and other data output from the media sources are provided on a display system having multiple displays where each display corresponds to a particular media source. Input devices such as keyboards, mice, and touchpads may be used to operate the control computer and control media sources based on cursor position.

### TECHNICAL FIELD

The present disclosure relates to integrated control systems. In some examples, the techniques of the present disclosure provide mechanisms for efficiently managing and manipulating multiple media sources.

### DESCRIPTION OF RELATED ART

A control computer presents the video output from a computer system on a display connected to the control computer. Input devices at the control computer can be used to manipulate the computer system. In some examples, a control computer presents the video output from multiple computer systems on a display connected to the control computer. Input devices at the control computer can be used to select a particular computer system for manipulation.

However, conventional systems provide somewhat limited mechanisms for controlling the computer systems. Consequently, the techniques of the present invention provide improved mechanisms for managing and manipulating devices connected to a control computer.

### Overview

Mechanisms are provided for efficiently manipulating devices such as computer systems, cameras, recorders, sensors, etc., referred to herein as media sources. The media sources are connected to a control computer over a network. Output such as video and other data output from the media sources are provided on a display system having multiple displays where each display corresponds to a particular media source. Input devices such as keyboards, mice, and touchpads may be used to operate the control computer and control media sources based on cursor position.

These and other features of the present invention will be presented in more detail in the following specification and the accompanying figures, which illustrate particular embodiments of the invention.

### BRIEF DESCRIPTION OF THE DRAWINGS

The disclosure may best be understood by reference to the following description taken in conjunction with the accompanying drawings, which illustrate particular embodiments of the present invention.

FIG. 1 is a diagrammatic representation showing an integrated control system.

FIG. 2 is illustrates one example of providing control input to media sources and receiving output from the media sources.

FIG. 3 is a diagrammatic representation showing displays corresponding to media sources.

FIG. 4 is a diagrammatic representation showing a display.

FIG. 5 is a process flow diagram showing a technique for associating input signals.

FIG. 6 is a process flow diagram showing a technique processing input.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular interfaces and networks. However, it should be noted that the techniques and mechanisms of the present invention can be used with a variety of interfaces and networks. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Many remote desktop agents provide a user at a control computer the ability to manipulate a computer system. For example, tools such as pcAnywhere™ available from Symantec Corporation allow a user to connect to remote devices over a network to manage and manipulate the remote devices. Virtual Network Computing or VNC™ available from RealVNC Limited provides remote control software that allows a user to view and interact with a computer system using a program on another computer on the Internet.

The techniques of the present invention recognize that the control of the individual computer systems remains limited. Consequently, a control computer is provided with an interface to allow efficient control and manipulation of a variety of individual media sources. In many instances, these media source systems are computer systems each with their own processors, memory, storage, input interfaces, and output interfaces. According to particular embodiments, media sources include computing devices and keyboard and mouse-controlled media sources. Examples of media sources include pan-tilt-zoom (PTZ) cameras, digital video recorders (DVR), computer systems, sensors, recorders, etc. Media sources may also include various types of listening devices such as directional microphones, seismic sensors, temperature monitors, and other data acquisition devices.

According to various embodiments, the control computer has an input device such as a mouse, touchpad, touchscreen, trackball, keyboard, keypad, etc., as well as one or more displays. The control computer may be connected to various media source over a Universal Serial Bus (USB) network or a single Internet Protocol (IP) network such as Ethernet. Media source would include drivers and/or other software and firmware that allow communication with the control computer over a network. In other particular embodiments, video output from the media sources would be provided over a video over analog or digital video interface such RGB or DVI while input to the media source would be provided over Ethernet or switched USB. In still other examples, video output and other output is provided over an IP network and input control signals are provided over the same IP network, but input control signals are converted to USB or PS-2 before connection to the media source. This makes use of existing USB or PS2 drivers already installed on a media source and obviates the need to put client software on the media source.

According to various embodiments, each media source has a corresponding display. In some examples, the displays are placed in a tiled arrangement or an array arrangement so that information on the display can be viewed and accessed efficiently. According to particular embodiments, each media source is connected to a corresponding display over a video interface such as RGB, Digital Visual Interface (DVI) or High Definition Multimedia Interface (HDMI), RCA, s-video, etc., although other interfaces including network type interfaces are contemplated.

In particular embodiments, a single control computer is connected to numerous media sources over network interfaces and output is provided to multiple separate displays. The multiple separate displays may be arranged in a grid or array or may be separately located.

In many instances, switching between different media sources and a control computer can be relatively awkward. For example, in a display system example, a user may have to enter individual Internet Protocol addresses associated with the media source the user wishes to control. Other examples require extensive sequences of mouse clicks to control the appropriate media source.

A variety of systems can take advantage of efficient switching between modes. In one example, a control computer connected to two media sources over a network provide a user with the ability to switch between control of the media sources and operation of a control computer. Each media source provides output data to its own corresponding display. In particular embodiments, moving a cursor into a particular display automatically allows the control computer to access the corresponding media source. No IP address input or mouse clicking is required. Although each media source has its own corresponding display, it should be noted that in particular embodiments, a control computer display may show multiple windows associated with individual media sources as well.

Alternate mechanisms can be used to switch between control of media sources and the control computer. In a particular embodiment, selecting a box using a keyboard in a particular display automatically allows the control computer to access the corresponding media source. In other embodiments, a hot-key combination may select the media source or control computer to be operated by the common mouse and keyboard. Yet other additional embodiments use an overlaid control selection menu or buttons that can be selected by the common mouse and keyboard.

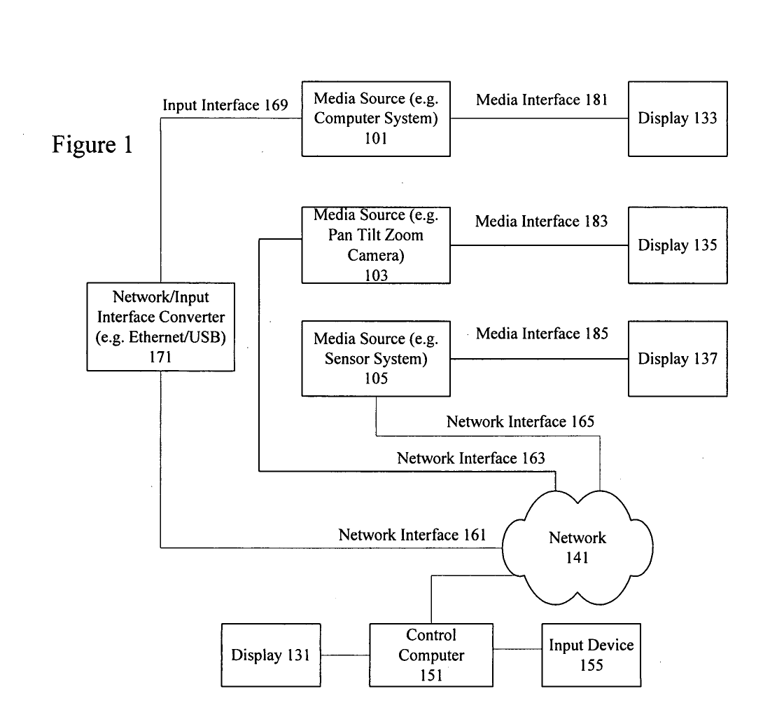

FIG. 1 is a diagrammatic representation showing one example of a system that can use the techniques of the present invention. The system includes a control computer 151. According to various embodiments, the control computer 151 is a computer system connected to an input device 155 such as a keyboard, mouse, touchpad, keypad, touchscreen, etc as well as a network interface connected to a network 141. The control computer 151 may also be connected to display 131. In particular embodiments, the network 141 can be one of a variety of different networks, such as Ethernet, wireless, serial, or Bluetooth™. In particular embodiments, media sources 101, 103, and 105 may be computer systems, Pan-Tilt-Zoom (PTZ) cameras, Digital Video Recorders (DVRs), sensors, microphones, etc.

According to various embodiments, the network 141 is connected to media sources 101, 103, and 105 through network interfaces 161, 163, and 165. In particular embodiments, any device that can be manipulated using input devices such as keyboard and mice to provide media is referred to herein as a media source. According to various embodiments, a camera is manipulated using an input remote to provide video. Each media source 101, 103, and 105 may include a processor and memory and may be connected to a keyboard and a mouse. Instead of requiring input devices directly connected to each media source, the media sources 101, 103, and 105 can be controlled by input devices connected to a control computer 151. The input device control signals can be conveyed over the network 141 to operate individual media sources 101, 103, 105. According to various embodiments, media sources 101, 103, and 105 may simply be processing systems, or controlled media sources without attached input devices.

According to various embodiments, media sources 101, 103, and 105 include computer systems, pan tilt zoom cameras, directional microphones, video recorders, sensors, and detectors. In particular embodiments, a media source 101 may be connected to the control computer 151 through one or more networks to input interface converter 171. In some examples, the network to input interface converter 171 converts Ethernet packets from a control computer 151 to USB or PS2 signals at a media source input interface. Converting network packets to input interface signals allows use of standard input interface drivers already installed on a media source and removes the need to put client software on the media source.

According to various embodiments, media sources 101, 103, and 105 can use network or media interfaces to send output to displays 133, 135, and 137. In particular embodiments, media output is sent over a video interface like HDMI, DVI, RGB, RCA, s-video, etc. In other embodiments, media output is sent over a network to remote displays.

In particular embodiments, the control computer 151 receives data such as video and audio data from media sources 101, 103, and 105 over network interfaces. According to particular embodiments, the control computer 151 performs processing that involves receiving data such as video, modifying the data, and/or selecting data from the media sources 101, 103, and 105. The displays 131, 133, 135, and 137 may include a standard monitor, screen, display, projector, or combination of multiple monitors, screens, displays, and projectors. Other output devices such as speakers can also be included. The control computer 151 also receives input signals from one or more input devices 155 using a variety of possible interfaces.

According to various embodiments, the keyboard and mouse input from the control computer 151 received at media sources 101, 103, and 105 is used to configure and manipulate media sources 101, 103, and 105 and corresponding displays 133, 135, 137. Objects in displays 133, 135, and 137 can be controlled using input devices connected to the control computer 151. According to various embodiments, the objects in displays 133, 135, and 137 are controlled with a single mouse spanning multiple displays. In some examples, displays 133, 135, and 137 correspond to media sources 101, 103, and 105 respectively.

In particular embodiments, a mouse pointer can start a video feed from media source 101 in display 133. The video feed itself may be provided on a display 133. In other embodiments, the video output from the media sources 101, 103, and 105 are provided on an array of displays or grid of displays.

According to various embodiments, the control computer 151 may display a plurality of labeled rectangles, or reduced resolution windows, each associated with one of the media sources or other controlled media sources. In particular embodiments such a control computer display may be rendered as the function of a network-transmitted Java applet, such as a WCP Control Panel from RGB Spectrum of Alameda, Calif.

Communication between the control computer and media sources can be encrypted. All communications within the integrated control system with keyboard video and mouse (KvM) can be secure. It should be noted that although the components of an integrated control system with keyboard video and mouse (KvM) are shown as separate entities, it will be recognized that some entities can be combined with others. For example, in some examples, one of the media sources can also be a control computer 151. A variety of arrangements are possible as will be appreciated.

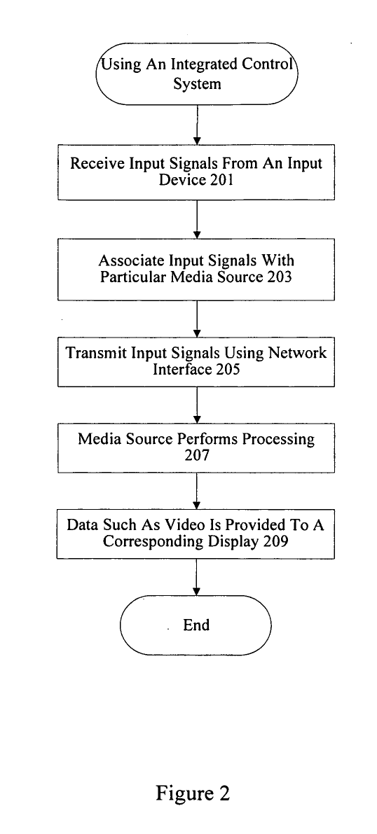

FIG. 2 illustrates one example of a technique for using an integrated control system. At 201, a control computer receives input signals from an input device such as a mouse, touchpad, touchscreen, keyboard, etc. At 203, the control computer associates the input signals with a particular media source. At 205, the control computer transmits the input signals as network packets to a network address associated with the particular media source. In particular embodiments, the network packets are converted to USB or PS2 signals at a converter prior to input into a media source interface.

At 207, the media source performs processing. In some embodiments, the media source sends data out using a network interface. In other particular embodiments, the media source sends data such as video data out of a DVI or HDMI interface. The media data is provided from the media source to a corresponding display at 209. In particular embodiments, the media sources sends the video to a display in a grid of displays using video graphics corresponding to RGB, DVI, HDMI, etc. In particular embodiments, video inputs may be composite, component, or S-Video.

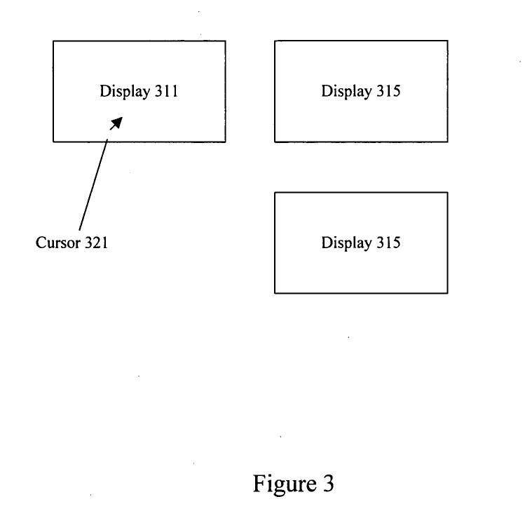

FIG. 3 is a diagrammatic representation showing displays corresponding to individual media sources. According to various embodiments, the system includes displays 311, 313, and 315, each corresponding to a particular media source. In particular embodiments, the displays are arranged as a tiled grid or array of displays. In other embodiments, the displays may be disparate. In particular embodiments, each media source is connected to a corresponding display 311, 313, and 315 using a video, network, or other media interface. According to various embodiments, the system includes a cursor 321 associated with a control computer input device. The displays 311, 313, and 315 are associated with media sources such as source computers, PTZ cameras, sensors, etc. Although a cursor 321 is shown, it should be noted that some systems may have multiple cursors while other systems have none at all.

Any video including images and data in displays 311, 313, and 315 may be provided over direct video connections, or over a sufficiently high-speed network. Control information such as cursor control may be provided over a network. According to various embodiments, a cursor 321 is associated with a particular cursor depiction. A single input device connected to a control computer can be used to manage and manipulate media sources corresponding to individual monitors or displays.

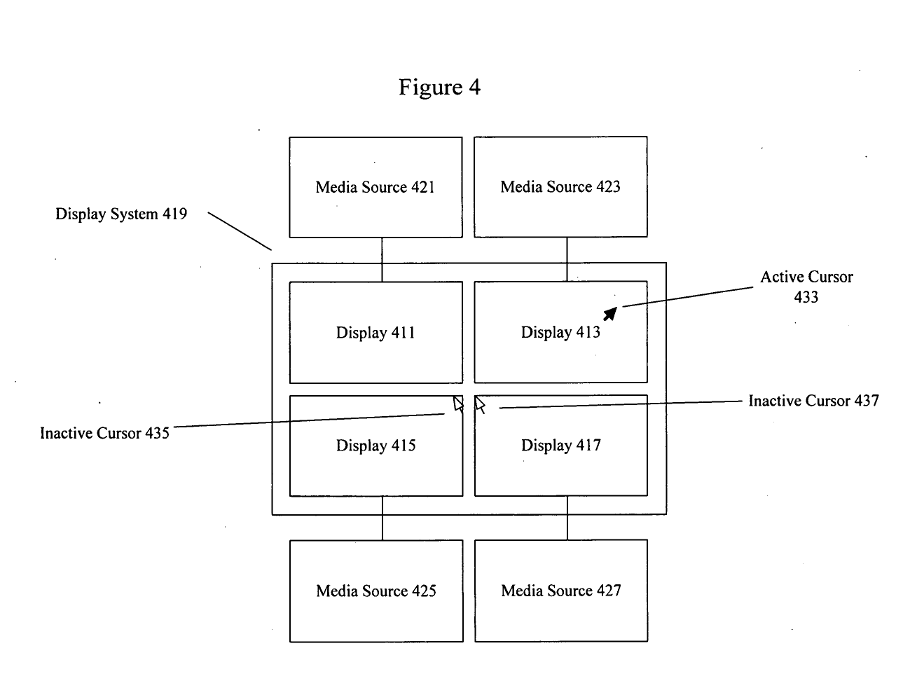

FIG. 4 is a diagrammatic representation showing a particular example of controlling a multiple display system. According to various embodiments, displays 411, 413, 415, and 417 have a one-to-one correspondence with media sources 421, 423, 425, and 427. In some embodiments, display 411 is connected to media source 421 using a video interface, display 413 is connected to a media source 423 using a multimedia interface, display 415 is connected to media source 425 over a network, and display 417 is connected to media source 427 over a hybrid network. Displays 411, 413, 415, and 417 are separate displays arranged in a tiled or grid configuration in display system 419.

According to various embodiments, a control computer controls active cursor in display 413 and corresponding media source 423. When the cursor moves from display 413 to display 417, the cursor in display 413 becomes inactive and the inactive cursor 433 becomes active. Similarly, when the cursor moves from display 413 to display 415, the cursor in display 413 becomes inactive and the inactive cursor 435 becomes active. In another example, when the cursor moves from display 413 to display 411, a new cursor is shown in display 411 where there was previously no cursor. It is recognized that media sources 421, 423, 425, and 427 and corresponding displays 411, 413, 415, and 417 may or may not have their own cursors. In some examples, none of the media sources 421, 423, 425, and 427 and corresponding displays 411, 413, 415, and 417 have cursors. The ones that do have cursors can have activated, changed in appearance, and/or manipulated by the control computer input device.

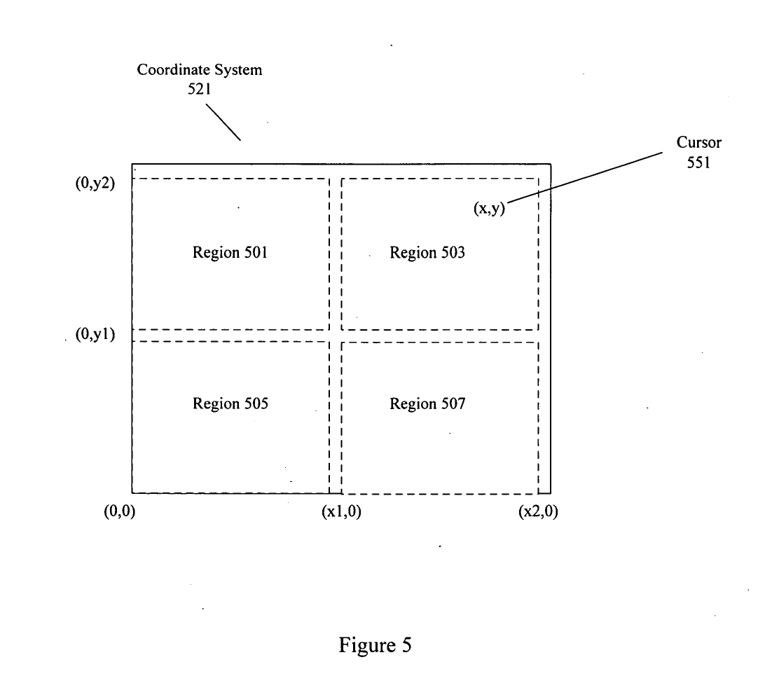

FIG. 5 illustrates one particular example of a mechanism for selecting a media source for control by a control computer based on cursor position. Regions 501, 503, 505, and 507 correspond to separate displays. In typical arrangements having multiple displays, slight gaps will occur between displays. According to various embodiments, the gaps are treated as non-existent in a coordinate space so that a cursor is always shown in one of regions 501, 503, 505, and 507. According to various embodiments, the cursor 551 has a coordinate corresponding to an x-coordinate and a y-coordinate 463. In particular embodiments, every position on a coordinate system 521 has a particular x-coordinate y-coordinate pairing. Regions 501, 503, 505, and 507 also have locations specified by sets of x-coordinate y-coordinate pairings. In some examples, regions 501, 503, 505, and 507 may correspond to displays having different sizes and resolutions. Alternatively, a smaller number of coordinates along with width and height information may be used.

A variety of mechanisms can be used to internally represent a mouse position, such as radians and length, but all of these mechanisms will be referred to herein as providing an x-coordinate and a y-coordinate position for the mouse pointer. According to various embodiments, the bottom left corner of a display arranged in the bottom left corner of a display system to a (0,0) coordinate position while the top right corner of a top right display corresponds to a position (x2,y2). When a cursor has coordinates between (0,0) and (x1,y1), the cursor controls a media source corresponding to region 505. When a cursor has coordinates between (x1,0) and (x2,y1), the cursor controls a media source corresponding to region 507. When a cursor has coordinates between (0,y1) and (x1,y2), the cursor controls a media source corresponding to region 501. When a cursor has coordinates between (x1,y1) and (x2,y2), the cursor controls a media source corresponding to region 503.

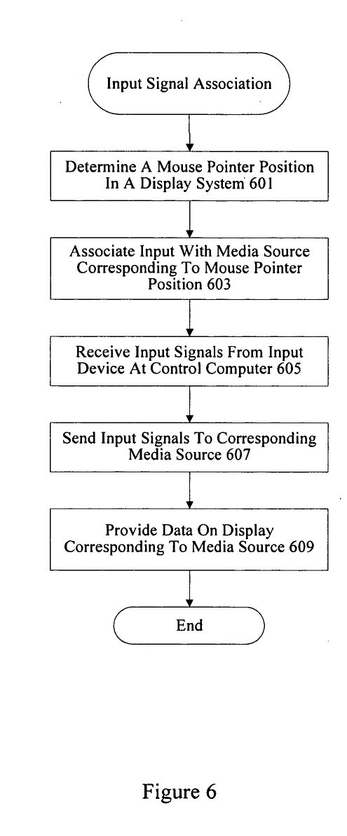

FIG. 6 is a flow process diagram showing one example of a technique for associating input signals with the appropriate media source. At 601, a mouse pointer position is determined. In particular embodiments, it is determined what display, monitor, or screen the mouse pointer is residing in. In other particular embodiments, the mouse pointer position associated with an x-coordinate and a y-coordinate in a display system is determined. In some examples, a position may be determined by an application. In other examples, the position may be determined by an operating system or even firmware and the position information may be passed through application program interfaces. At 603, input is associated with a media source based on mouse pointer position. In some examples, no mouse pointer is required, as a user may select option boxes using a keypad, touchscreen, etc. At 605, input signals are received from the control computer. The input signals may be keyboard, touchpad, mouse, microphone, etc., signals from a control computer.

At 607, input signals are sent to a media source selected based on cursor position or other selection mechanism. At 609, data is sent to the display corresponding to the media source.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method, comprising:
receiving an input signal from an input device connected to a control computer, the control computer connected to a plurality of media sources over a network, each of the plurality of media sources connected to a corresponding display;
associating the input signal with a first media source based on an input signal cursor position;
receiving output data from the first media source, the output data received at a first display;
sending the output data to the first display corresponding to the first media source.

2. The method of claim 1, wherein the first media source is connected to the first display using Digital Visual Interface (DVI).

3. The method of claim 1, wherein the plurality of media sources include computer systems and Pan-Tilt-Zoom (PTZ) cameras.

4. The method of claim 1, wherein the plurality of media sources include Digital Video Recorders (DVRs).

5. The method of claim 1, wherein the plurality of media sources include sensors and detectors.

6. The method of claim 1, wherein the input signal is associated with the first media source when the input signal cursor position resides within the first display.

7. The method of claim 1, wherein the first media source has an input interface connected to the network through a network/input interface converter.

8. The method of claim 7, wherein the network/input interface converter is an Ethernet/USB converter.

9. The method of claim 7, wherein the network/input interface converter allows the control computer to operate the first media source without installing client software on the first media source.

10. A system, comprising:
a control computer having an input device;
a plurality of media sources connected to the control computer using a network;
a display system comprising a plurality of displays, each of the plurality of displays individually connected to a media source, wherein input signals from the input device are associated with a particular media source based on the position of the cursor in the display system.

11. The apparatus of claim 10, wherein the control computer is connected to the first display using Digital Visual Interface (DVI).

12. The apparatus of claim 10, wherein the plurality of media sources include computer systems and Pan-Tilt-Zoom (PTZ) cameras.

13. The apparatus of claim 10, wherein the plurality of media sources include Digital Video Recorders (DVRs).

14. The apparatus of claim 10, wherein the plurality of media sources include sensors and detectors.

15. The apparatus of claim 10, wherein the input signal is associated with the first media source when the input signal cursor position resides within the first display.

16. The apparatus of claim 10, wherein the first media source has an input interface connected to the network through a network/input interface converter.

17. The apparatus of claim 16, wherein the network/input interface converter is an Ethernet/USB converter.

18. An apparatus, comprising:
means for receiving an input signal from an input device connected to a control computer, the control computer connected to a plurality of media sources over a network, each of the plurality of media sources connected to a corresponding display;
means for associating the input signal with a first media source based on an input signal cursor position;
means for receiving output data from the first media source, the output data received at a first display;
means for sending the output data to the first display corresponding to the first media source.

19. The apparatus of claim 18, wherein the control computer is connected to the first display using Digital Visual Interface (DVI).

20. The apparatus of claim 18, wherein the plurality of media sources include computer systems and Pan-Tilt-Zoom (PTZ) cameras.
